(19) United States
(12) Patent Application Publication
(10) Pub. No.: US 2024/0368454 A1
(43) Pub. Date: Nov. 7, 2024

(54) EMULSIFIER COMPOSITIONS

(71) Applicant: GLENSOL (PTY) LIMITED, Saxonwold (ZA)

(72) Inventor: Fritz GREUB, Saxonwold (ZA)

(21) Appl. No.: 18/688,345

(22) PCT Filed: Aug. 17, 2022
(86) PCT No.: PCT/IB2022/057701

§ 371 Date: Feb. 29, 2024

(30) Foreign Application Priority Data
Sep. 2, 2021 (ZA) 2021/06400

(51) Int. Cl. C09K 8/584

(52) U.S. Cl. CPC C09K 8/584

(57) ABSTRACT

This invention relates to an emulsifier composition and more specifically, but not exclusively to a micro emulsifier composition for use in enhanced oil recovery (EOR). The emulsifier composition comprises a mixture of at least one ethoxylated alkyl phenol, at least one fatty acid amide, and at least one unsaturated fatty acid. The invention further relates to a method of forming an aqueous emulsion using the emulsifier composition, as well as a process of separating a hydrocarbon composition from an associated substrate making use of the same.

### FIELD OF THE INVENTION

This invention relates to an emulsifier composition and more specifically, but not exclusively to a micro emulsifier composition for use in enhanced oil recovery (EOR) and oil solubilisation from solids, surfaces and porous materials.

### BACKGROUND TO THE INVENTION

Considerable literature is available on chemicals that enhance oil recovery, yet there have been few successful commercial projects.

General textbooks on reservoir engineering characterize chemical methods of enhanced oil recovery as being economically marginal and technically complex. This is because the cost of the surfactants can be expensive relative to the value of any increase in oil recovery. This is further compounded by the possible loss of surfactants to the reservoir formation during floods.

In many field situations, it has been difficult to bring the injected water containing EOR-chemicals into contact with bypassed oil. The injected water containing EOR chemicals simply flow around regions that contain residual oil. Technical problems are caused by the sensitivity of surfactant properties to differing reservoir formation water chemistry and mineralogy, which necessitate a design stage to specifically tailor a combination of surfactants and their co-surfactants for particular reservoir characteristics. Extensive design and compatibility studies are therefore needed.

Therefore, in addition to the costs of implementing a field-scale EOR project, a considerable investment is also necessary at the design stage, thus a chemical EOR project is inherently risky, may take a long time to bring to fruition and even longer to pay back a financial investment.

Previous characterizations of EOR treatments include low and high concentration surfactant floods, techniques that form surfactants using chemicals already present in the oil (alkali flooding) and those that use evaluation of microbially produced bio-surfactants.

Many of these surfactants are not efficient and effective to the same extent in fresh and saltwater, i.e. they do not prove to be very robust as additive. Further, these surfactants do not perform well at low concentrations. These additives are also designed to be recovered for reinjection, thus increasing the economic risk in EOR projects.

### Object of the Invention

It is therefore an object of the invention to provide a micro emulsifying composition with which the aforesaid disadvantages can be overcome or at least minimised. It is a further object of the present invention to provide a micro emulsifying composition for use in EOR and oil solubilisation from solids, surfaces and porous materials.

### SUMMARY OF THE INVENTION

According to a first aspect of the invention, there is provided an emulsifier composition comprising a mixture of:
at least one ethoxylated alkyl phenol in which the alkyl group is a straight or branched chain composed of between 3 and 20 carbon atoms;
at least one fatty acid amide containing a straight or branched chain composed of between 3 and 20 carbon atoms; and
at least one unsaturated fatty acid containing a straight or branched chain composed of between 3 and 20 carbon atoms.

In an embodiment, the ethoxylated alkyl phenol may be a non-ionic surfactant. In a preferred embodiment, the ethoxylated alkyl phenol is a compound of general formula:

R(OCH₂CH₂)ₙOH

in which R is an alkyl substituted phenyl moiety and n represents the number of ethoxy groups, being an integer between 2 and 20.

In an embodiment, the ethoxylated alkyl phenol may be polyoxyethylene (POE) nonylphenol. In a preferred embodiment, the ethoxylated alkylphe may be POE-(5) or POE-(6)-nonylphenol.

In an embodiment, the at least one fatty acid amide may be a fatty acid dialkanolamide. In a preferred embodiment, the at least one fatty acid may include lauric acid diethanolamide. In a further preferred embodiment, the at least one fatty acid dialkanolamide may be coconut diethanolamide.

In an embodiment, the at least one unsaturated fatty acid may be oleic acid.

In an embodiment, the emulsifier composition may contain polyoxyethylene-nonylphenol and coconut diethanolamide.

In an embodiment, the emulsifier composition may contain:
between 1 and 3 parts by volume of the at least one ethoxylated alkyl phenol,
between 2 and 5 parts by volume of the at least one fatty acid diethanolamide, and
between 1 and 3 parts by volume of the at least one unsaturated fatty acid.

In a preferred embodiment the emulsifier composition contains 1 part by volume polyoxyethylene-nonylphenol, 2 parts by volume coconut diethanolamide and 1 part by volume oleic acid.

According to a second aspect of the invention, there is provided a method of forming an aqueous emulsion of a substantially water insoluble composition, comprising the step of mixing the substantially water insoluble composition with an aqueous medium containing an emulsifier composition as described above.

In this aspect of the invention the aqueous medium may contain a quantity of the emulsifier which is sufficient to form a micro-emulsion of the water insoluble composition in the aqueous medium and below the quantity that is necessary to form a solid emulsion of the water insoluble composition in the aqueous medium, thereby allowing the micro-emulsion to be demulsified to separate the water and the water insoluble composition. This variant of this aspect of the invention is of particular application in the recovery of oil from oil reservoirs.

In another variant of this aspect of the invention the aqueous medium may contain a quantity of the emulsifier composition which is sufficient to form a solid emulsion of the water insoluble composition with the aqueous medium, to allow the solid emulsion to be mixed with the water to form a cloudy water and then to dilute the cloudy water with more water thereby allow the water insoluble composition to be dissipated in the water. This variant of this aspect of the invention is of particular application in the remediation of polluted waters or soil, such as water or soil that has been contaminated by oil spillage.

In an embodiment, the substantially water insoluble composition may be a highly viscous or solid bitumen, tar or oil. Here the addition of the emulsifier composition has the effect of reducing the viscosity of the oil phase so as to create a pumpable or pourable single phase with a reduced viscosity. This embodiment has application to cleaning petroleum infrastructure fouled by heavy oil and sludges.

According to a third aspect of the invention, there is provided a process of separating a hydrocarbon composition from an associated substrate comprising the steps of contacting the hydrocarbon with an aqueous medium containing an emulsifier composition as described above, to form an aqueous emulsion of the hydrocarbon composition and then separating the aqueous emulsion of the hydrocarbon from the substrate.

In an embodiment, the emulsion formed in this process may be a micro-emulsion.

In an embodiment, the hydrocarbon may be any substantially water insoluble hydrocarbon.

In an embodiment, the hydrocarbon and its associated substrate may be oil in an oil reservoir from which oil is being recovered, or a tar-sand, or an oil contaminated soil in need of environmental remediation, or a product required to be decontaminated from a contaminating oil, such as a pipe-line requiring unblocking or a fouled storage vessel in need of remediation. The oil may thus be a mineral oil. However, the oil may also be a vegetable oil, a fruit oil or an animal oil.

The aforementioned processes thus also include the use of the emulsifier in the reduction of heavy metals and salt, and as a micro emulsifier in the production of medication and for desalination.

The water used as the aqueous medium may be either fresh water with low quantities of dissolved solids or it may be saline water, such as sea water, with relatively high quantities of dissolved solids therein.

The water may be used at an elevated temperature, i.e. as hot (>70° C.) water. However, the water may also be used at ambient temperature, i.e. as cold water (ca 20° C.).

In an embodiment, the emulsifier composition may be used at a concentration of between 0.0005% and 5% by volume of the cold water (20° C.) embodiment, preferably at concentrations of between 0.0005% and 2%, more preferably at concentrations of between 0.0005% and 1%, most preferably at concentrations of between 0.0005% and 0.008% by volume.

The invention will now be described by way of an example without thereby limiting the scope of the invention to the disclosed example.

### DESCRIPTION OF EXAMPLE EMBODIMENTS OF THE INVENTION

The presently disclosed subject matter will now be described more fully hereinafter with reference to the accompanying Examples, in which representative embodiments are shown. The presently disclosed subject matter can, however, be embodied in different forms and should not be construed as limited to the embodiments set forth herein. Rather, these embodiments are provided so that this disclosure will be thorough and complete, and will fully convey the scope of the embodiments to those skilled in the art.

In accordance with a non-limiting embodiment of the invention, an emulsifier composition was made up as follows:

1 litre of polyoxyethylene-nonylphenol, 2 litres of coconut diethanolamide and 1 litres of oleic acid was measured out and mixed together by first placing the polyoxyethylene-nonylphenol in a stirred vessel, then adding the coconut diethanolamide with stirring to the vessel, and finally adding the oleic acid with stirring. The mixing was carried out at ambient temperature of about 20° C. The resultant mixture is hereinafter referred to as Glensol.

Other substances that are conventionally used in the oil industry such as anti-corrosive agents and stabilizers may be added to the Glensol composition, but in the example below such agents were not included.

A simulated oil recovery experiment was then carried out as follows:

A microfluidic bead pack was adapted to allow the preliminary evaluation of water flooding with the Glensol composition as a method of enhanced oil recovery for heavy oil. Bead pack experiments serve to act as a simplification of natural reservoir conditions.

These experiments show the recovery of oil from bypassed regions.

Soda-lime glass-beads were used for experiments and these had a high sphericity 22 μm diameter particle-size standard. Beads were introduced through a channel 500 μm in breadth and ˜46 μm in depth until a pack of suitable length accumulated behind a gap filter.

During experiments the bead pack was flooded with heavy oil and to promote the aging of the system to an oil-wet state it was warmed at 30° C. The oil used was from Siljian (Sweden) and had an asphaltene+resin content of 36%, an API value of 18% 10 000 cp. Tap water (TDS<500 mg/ [symbol] ) was used for freshwater floods and seawater for saltwater floods (TDS<35 000 mg/ [symbol] ). The same stock solution of the Glensol was used to make up the treated saltwater and freshwater to practice the process according to the invention.

The device was cooled to room temperature before use. Two or more phases of recovery were used. The first phase comprised primary recovery by water drive. During this stage cold water (20° C.) was used. Second and subsequent phases comprised flooding by one of three techniques; (1) cold water (20° C.), (2) hot water between 70° C. to 85° C. or (3) water with a 5μ [symbol] / [symbol] (5 ppm) concentration of the surfactant (Glensol).

The bead pack was videoed during the experiments and still-images were point-counted to measure water saturation and the volume of fluids exiting the bead pack. Table 1 lists the experiments performed for the evaluation of the Glensol composition as a heavy oil recovery additive.

Results for preliminary core-flood experiments are summarised in Tables 1 and 2. During all experiments a flood with cold water (20° C.) was performed to drive a ˜10000 cp heavy oil from a bead pack (the primary oil recovery phase). Subsequent to this an EOR method is applied (flooding with the additive or hot water or an extended flood with cold water). The EOR phase was extended by flooding with an equal pore volume. For both cold- and saltwater, enhanced oil recovery by flooding with the Glensol composition greatly increased oil recovery and reduced watercut relative to continued flooding with cold water. Increases in oil recovery and reductions in watercut achieved by the surfactant compare favourably or exceeded those of hot water.

In the Tables below the following legend applies:
* Oil recovered=the % of oil initially in place recovered.
Primary recovery=% recovered after water drive;
EOR=% recovered after equal volume of water to primary phase used to implement EOR technique;
Extended=% recovered after extension of EOR phase. Approximately equal pore volumes used for each experiment.
* % EOR=% of oil initially in place recovered by first EOR technique, number in brackets is % enhancement in oil recovery.
***Water cut during EOR. Note that for extended flooding, there is no reduction, hence this number is positive.

TABLE 1
Summary of results using freshwater

| | Oil Recovered* (%) | | | % | Watercut during EOR*** | | |
|---|---|---|---|---|---|---|---|
| | Primary | EOR | Extended | EOR** | Lowest | Average | Reduction |
| Glensol (5 μ [symbol] / [symbol] ) | 33 | 70 | 93 | 37 (55) | 64 | 67 | −10 |
| | 27 | 67 | 90 | 40 (60) | 60 | 67 | −15 |
| Cold water | 27 | 37 | 55 | 10 (30) | 80 | 82 | +5 |
| | 27 | 43 | | 16 (37) | 85 | 85 | +11 |
| Hot water (>70° C.) | 27 | 40 | — | 13 | 65 | 85 | −28 |
| | | 46 | — | 16 | 64 | 78 | −28 |
| Hot water (85° C.) | | 63 | — | 36 (57) | 55 | 71 | −38 |
| | | | | | | | −10 |

TABLE 2
Summary of results using saltwater

| | Oil Recovered* (%) | | | % | Watercut during EOR*** | | |
|---|---|---|---|---|---|---|---|
| | Primary | EOR | Extended | EOR** | Lowest | Average | Reduction |
| Glensol (5 μ [symbol] / [symbol] ) | 35 | 72 | 83 | 37 (54) | 140 | 51 | −31 |
| Cold water | 40 | 50 | | 10 (20) | 50 | 66 | +27 |

Images of the bead pack in, before and after flooding with the Glensol composition show the recovery of oil from bypassed regions. Relative to other methods the surfactant appeared efficient at accessing zones of bypassed oil.

The Glensol composition may also be used to remove heavy oil residues to remediate contaminated land and clean surfaces. In this application the composition has been found to react rapidly, penetrating asphaltic deposits to clean oil from surfaces. This ability appears to transfer to a dynamic environment at the laboratory-scale. Additionally; the experimental results for the additive demonstrated that the additive out-performs cold- and hot-water floods in fresh- and salt-water.

It will be appreciated that a number of variations in detail of the invention are possible without departing from the scope and spirit of the invention as disclosed.

1. An emulsifier composition comprising a mixture of
at least one ethoxylated alkyl phenol in which the alkyl group is a straight or branched chain composed of between 3 and 20 carbon atoms;
at least one fatty acid amide containing a straight or branched chain composed of between 3 and 20 carbon atoms; and
at least one unsaturated fatty acid containing a straight or branched chain composed of between 3 and 20 carbon atoms.

2. The emulsifier composition of claim 1, wherein the ethoxylated alkyl phenol is be a non-ionic surfactant.

3. The emulsifier composition of claim 2, wherein the ethoxylated alkylpenol is a compound of general formula
R(OCH₂CH₂)ₙOH
in which R is an alkyl substituted phenyl moiety and n represents the number of ethoxy groups, being an integer between 2 and 20.

4. The emulsifier composition of any one of claims 1 to 3, wherein the ethoxylated alkylphenol is polyoxyethylene (POE) nonylphenol.

5. The emulsifier composition of claim 4, wherein the ethoxylated alkylphenol is POE-(5) or POE-(6)-nonylphenol.

6. The emulsifier composition of any one of claims 1 to 5, wherein the at least one fatty acid amide is a fatty acid dialkanolamide.

7. The emulsifier composition of claim 6, wherein the at least one fatty acid includes lauric acid diethanolamide.

8. The emulsifier composition of claim 6, wherein the at least one fatty acid dialkanolamide is coconut diethanolamide.

9. The emulsifier composition of any one of claims 1 to 8, wherein the at least one unsaturated fatty acid is oleic acid.

10. The emulsifier composition of any one of claims 1 to 9, wherein the emulsifier composition contains polyoxyethylene-nonylphenol and coconut diethanolamide.

11. The emulsifier composition of any one of claims 1 to 10, wherein the emulsifier composition contains:
between 1 and 3 parts by volume of the at least one ethoxylated alkyl phenol,
between 2 and 5 parts by volume of the at least one fatty acid diethanolamide, and
between 1 and 3 parts by volume of the at least one unsaturated fatty acid.

12. The emulsifier composition of claim 11, wherein the emulsifier composition contains:
1 part by volume polyoxyethylene-nonylphenol,
2 parts by volume coconut diethanolamide and
1 part by volume oleic acid.

13. A method of forming an aqueous emulsion of a substantially water insoluble composition, comprising the step of mixing the substantially water insoluble composition with an aqueous medium containing the emulsifier composition of any one of claims 1 to 12.

14. The method of claim 13, wherein the substantially water insoluble composition is a highly viscous or solid bitumen, tar or oil.

15. A process of separating a hydrocarbon composition from an associated substrate comprising the steps of:
contacting the hydrocarbon with an aqueous medium containing the emulsifier composition of any one of claims 1 to 12, to form an aqueous emulsion of the hydrocarbon composition, and
separating the aqueous emulsion of the hydrocarbon from the substrate.

16. The process of claim 15, wherein the emulsion formed in the process is a micro-emulsion.

17. The process of either claim 15 or claim 16, wherein the hydrocarbon is any substantially water insoluble hydrocarbon.

18. The process of any one of claims 15 to 17, wherein the emulsifier composition is used at a concentration of between 0.0005% and 5% by volume.

19. The process of claim 18, wherein the emulsifier composition is used at a concentration of between 0.0005% and 2% by volume.

20. The process of claim 18, wherein the emulsifier composition is used at a concentration of between 0.0005% and 1% by volume.

21. The process of claim 18, wherein the emulsifier composition is used at a concentration of between 0.0005% and 0.008% by volume.
